(19) United States
(12) Patent Application Publication
(10) Pub. No.: US 2007/0210991 A1
(43) Pub. Date: Sep. 13, 2007

(54) Apparatus for driving plasma display panel

(76) Inventor: Joo-Yul Lee, Suwon-si (KR)

Correspondence Address: Robert E. Bushnell, Suite 300, 1522 K Street, N.W., Washington, DC, 20005, US

(21) Appl. No.: 11/648,580

(22) Filed: Jan. 3, 2007

(30) Foreign Application Priority Data
Mar. 7, 2006 (KR) 10-2006-0021294

(51) Int. Cl. G09G 3/28

(52) U.S. Cl. 345/66

(57) ABSTRACT

An apparatus for driving a plasma display panel that generates a power level to reduce manufacturing costs and pressure of circuitry elements. The plasma display panel is constructed with a plurality of electrodes. The apparatus includes a scan pulse application portion generating a scan pulse and outputting the scan pulse to first electrodes among the plurality of electrodes, a sustain pulse generation portion generating a sustain pulse, and a bootstrap portion performing a bootstrap operation using a high level and a low level of the sustain pulse, and generating a low level voltage of the scan pulse.

### CLAIM OF PRIORITY

This application makes reference to, incorporates the same herein, and claims all benefits accruing under 35 U.S.C. §119 from an application for APPARATUS OF DRIVING PLASMA DISPLAY PANEL earlier filed in the Korean Intellectual Property Office on 7 Mar. 2006 and there duly assigned Serial No. 10-2006-0021294.

### BACKGROUND OF THE INVENTION

1. Field of the Invention

The present invention relates to an apparatus for driving a plasma display panel, and more particularly, to an apparatus for driving a plasma display panel that generates a power level to reduce manufacturing costs and the pressure of circuitry elements.

2. Description of the Related Art

Plasma display panels (PDP) are large-sized flat display devices. Plasma display panels display desired images using visible rays generated by sealing a discharge gas between two substrates on which a plurality of electrodes are formed, applying a discharge voltage across the two substrates to generate ultraviolet rays in vacuum, and exciting phosphors formed in a certain pattern by using the vacuum ultraviolet rays

Apparatuses for driving a plasma display panel process image signals received from outside, convert image signals to driving control signals, and generate driving signals using driving control signals, a plurality of voltage sources, and a plurality of switching elements. The plurality of voltage sources are supplied from a power supply device. Plasma display panels have a variety of voltage levels between several tens of volts and several hundreds of volts. To generate various high voltages, the power supply device requires expensive circuitry elements according to the number of voltage levels, which increases manufacturing costs.

### SUMMARY OF THE INVENTION

It is therefore an object of the present invention to provide an improved apparatus for driving a plasma display panel.

It is another object to provide an apparatus for driving a plasma display panel that generates a power level to reduce manufacturing costs and the pressure of circuitry elements.

According to an aspect of the present invention, there is provided an apparatus for driving a plasma display panel constructed with a plurality of electrodes. The apparatus includes a scan pulse application portion generating a scan pulse and outputting the scan pulse to first electrodes among the plurality of electrodes, a sustain pulse generation portion generating a sustain pulse, and a bootstrap portion performing a bootstrap operation generating a low level voltage of the scan pulse by using a high level and a low level of the sustain pulse.

The bootstrap portion includes a bootstrap capacitor performing the bootstrap operation, and a clamping diode performing a clamping operation.

The bootstrap portion stores a difference between electric potentials of the high level and the low level of the sustain pulse in the bootstrap capacitor and the clamping diode, and inputs the high level of the sustain pulse to a first terminal of the bootstrap capacitor.

If a difference between electric potentials of the high level of the low level of the sustain pulse is Vs, and a clamping voltage of the clamping diode is Vc, after the bootstrap portion inputs the high level of the sustain pulse, a voltage of a second terminal of the bootstrap capacitor is −Vs+Vc and is used as a low level of the scan pulse.

The scan pulse application portion includes a scan pulse generation portion generating a high level of the scan pulse using the low level of the scan pulse and a first voltage source, and a scan switching portion sequentially outputting the high level and the low level of the scan pulse to the first electrodes.

The scan switching portion includes a first scan switching element outputting the high level of the scan pulse to the first electrodes, and a second scan switching element outputting the low level of the scan pulse to the first electrodes.

The scan pulse generation portion includes the first voltage source, a scan voltage switching element switching the low level of the scan pulse, and a scan capacitor storing the low level of the scan pulse. When the scan voltage switching element is turned on, the low level of the scan pulse is transferred to the second scan switching element, or the high level of the scan pulse generated by the low level of the scan pulse and the first voltage from the first voltage source being transferred to the first scan switching element.

The sustain pulse generator includes a second voltage source supplying the high level of the sustain pulse, a third voltage source supplying the low level of the sustain pulse, a second voltage switching element connected to the second voltage source and transferring the second voltage to a first node, and a third voltage switching element connected to the third voltage source and transferring the third voltage to the first node.

The bootstrap portion includes a bootstrap capacitor disposed between the first node and a second node, and a clamping diode disposed between the second node and a ground node.

When the second voltage switching element is turned on, a fourth voltage obtained by subtracting a clamping voltage applied to the clamping diode from the second voltage supplied from the second voltage source is stored in the bootstrap capacitor; and when the third voltage switching element is turned on, a voltage of the first node is the third voltage supplied from the third voltage source, a voltage of the second node is a fifth voltage obtained by subtracting the fourth voltage from the third voltage, and the fifth voltage is used as the low level of the scan pulse.

The third voltage is the ground voltage.

The apparatus further includes an energy recovery portion recovering wall charges from the plasma display panel to store them, or purging the stored wall charges to the plasma display panel in order to reduce power consumption when the sustain pulse is generated.

The energy recovery portion includes an inductor acting as a capacitance component of the plasma display panel to establish an LC resonance when the wall charges from the plasma display panel are recovered or the stored wall charges are purged, an energy recovery determination portion determining whether to recover the wall charges from the plasma display panel or to purge the stored wall charges to the plasma display panel, and an energy storage portion storing the recovered wall charges.

The energy recovery determination portion includes a falling switching element determining to recover the wall charges from the plasma display panel, and a rising switching element determining to purge the stored wall charges to the plasma display panel.

The apparatus further includes a rising ramp pulse generation portion generating a rising ramp pulse to be applied to the first electrodes, and a falling ramp pulse generation portion generating a falling ramp pulse to be applied to the first electrodes.

The falling ramp pulse application portion includes a falling ramp switching element receiving the low level of the scan pulse generated by the bootstrap portion to perform a ramp switching, and a Zener diode increasing the supplied voltage by a certain level.

The rising ramp pulse application portion includes a sixth voltage source, and a rising ramp switching element receiving a sixth voltage from the sixth voltage source to perform the ramp switching.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a plasma display panel driven by a plasma display panel driving apparatus according to an embodiment of the principles of the present invention;

FIG. 2 is a schematic diagram of an electrode layout of the plasma display panel illustrated in FIG. 1;

FIG. 3 is a block diagram of an apparatus for driving the plasma display panel 1 illustrated in FIG. 1;

FIG. 4 is a timing diagram of driving signals output by each driver illustrated in FIG. 3;

FIG. 5 is a circuit diagram illustrating a plasma display panel driving apparatus according to an embodiment of the principles of the present invention;

FIG. 6 is a circuit diagram illustrating a plasma display panel driving apparatus according to another embodiment of the principles of the present invention; and

FIG. 7 is a circuit diagram illustrating a plasma display panel driving apparatus according to another embodiment of the present invention.

### DETAILED DESCRIPTION OF THE INVENTION

The present invention will now be described more fully with reference to the accompanying drawings, in which exemplary embodiments of the invention are shown.

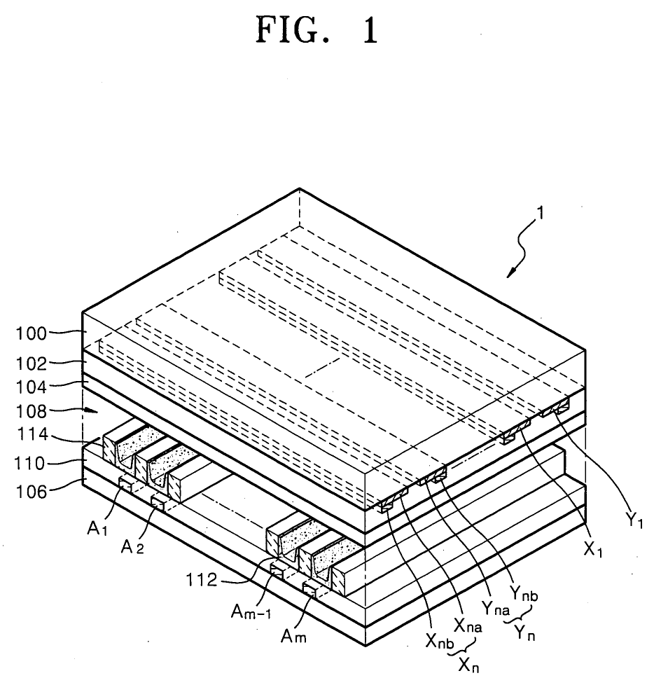

FIG. 1 is a perspective view of a plasma display panel 1 driven by a plasma display panel driving apparatus according to an embodiment of the present invention.

Referring to FIG. 1, address electrodes A₁, . . . , Aₘ, first and second dielectric layers 102 and 110, scan electrodes Y₁, . . . , Yₙ, sustain electrodes X₁, . . . , Xₙ, phosphor layers 112, barrier ribs 114, and an MgO protection layer 104 are formed between first and second substrates 100 and 106 of plasma display panel 1.

Address electrodes A₁, . . . , Aₘ are formed in a certain pattern on a surface of second substrate 106 facing toward first substrate 100. Second dielectric layer 110 is formed to cover address electrodes A₁, . . . , Aₘ. Barrier ribs 114 are formed parallel to address electrodes A₁, . . . , Aₘ on second dielectric layer 110. Barrier ribs 114 define discharge cells and prevent cross talkings between the discharge cells. Phosphor layers 112 are formed on second dielectric layer 110, overlying address electrodes A₁, . . . , Aₘ between barrier ribs 114. A red light emitting phosphor layer, a green light emitting phosphor layer, and a blue light emitting phosphor layer are sequentially disposed in phosphor layers 112.

Sustain electrodes X₁, . . . , Xₙ and scan electrodes Y₁, . . . , Yₙ are formed in a certain pattern on first substrate 100 facing toward second substrate 106 such that both sustain electrodes X₁, . . . , Xₙ and scan electrodes Y₁, . . . , Yₙ cross address electrodes A₁, . . . , Aₘ. Discharge cells are defined where both sustain electrodes X₁, . . . , Xₙ and scan electrodes Y₁, . . . , Yₙ intersect address electrodes A₁, . . . , Aₘ. Each of sustain electrodes X₁, . . . , Xₙ and each of scan electrodes Y₁, . . . , Yₙ are formed by coupling a transparent conductive electrode made from a material such as Indium Tin Oxide (ITO) with a metal electrode for increasing conductivity. First dielectric layer 102 is formed to cover sustain electrodes X₁, . . . , Xₙ and scan electrodes Y₁, . . . , Yₙ. To protect plasma display panel 1 from a strong electric field, protective layer 104, e.g., MgO layer, is formed to cover first dielectric layer 102. A gas for forming a plasma is sealed in a discharge space 108 between first and second substrates 100 and 106.

Plasma display panel 1 driven by the plasma display panel driving apparatus of the present invention is not limited to the structure illustrated in FIG. 1. In detail, plasma display panel 1 can be a 3-electrode type plasma display panel illustrated in FIG. 1 or a 2-electrode type plasma display panel constructed with two electrodes, can have a variety of structures and can be driven using the plasma display panel driving apparatus of the present invention.

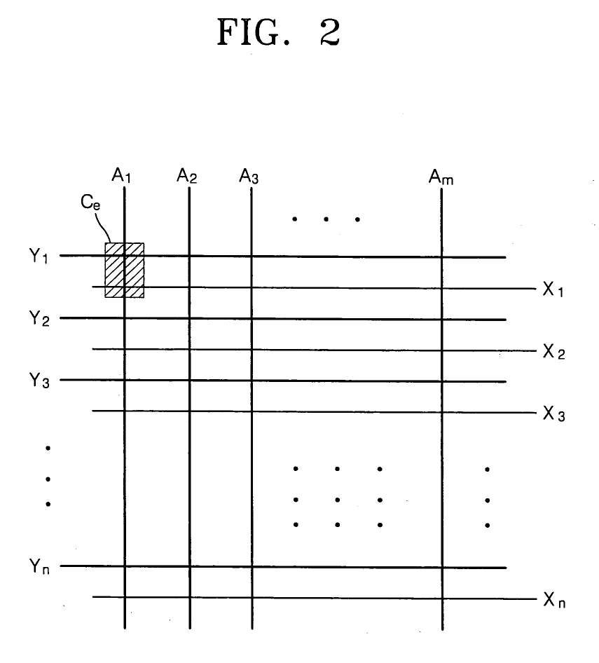

FIG. 2 is a schematic diagram of an electrode layout of plasma display panel 1 illustrated in FIG. 1.

Referring to FIG. 2, scan electrodes Y₁, . . . , Yₙ and sustain electrodes X₁, . . . , Xₙ are parallel to each other. Address electrodes A₁, . . . , Aₘ cross both scan electrodes Y₁, . . . , Yₙ and sustain electrodes X₁, . . . , Xₙ.

Discharge cells Ce are defined where both sustain electrodes X₁, . . . , Xₙ and scan electrodes Y₁, . . . , Yₙ intersect address electrodes A₁, . . . , Aₘ.

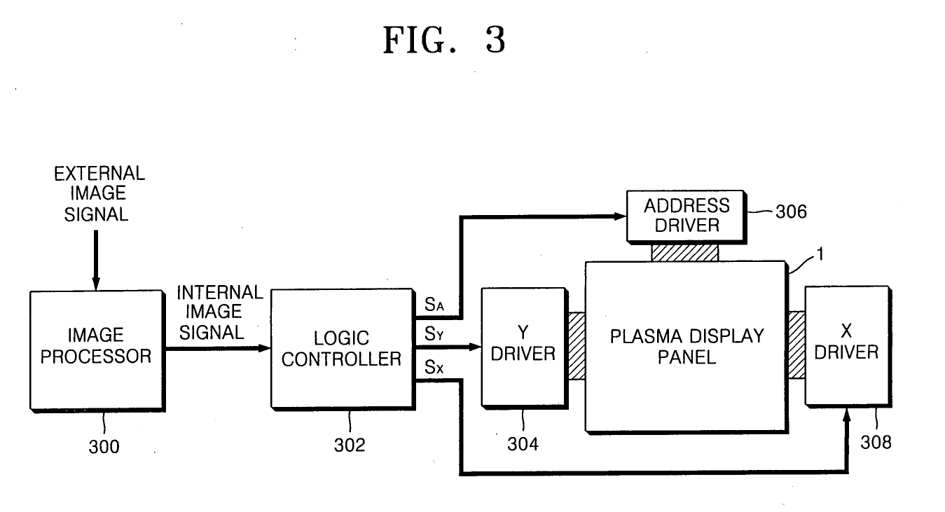

FIG. 3 is a block diagram of an apparatus for driving plasma display panel 1 illustrated in FIG. 1.

Referring to FIG. 3, the apparatus for driving plasma display panel 1 includes an image processor 300, a logic controller 302, a Y driver 304, an address driver 306, an X driver 308, and a plasma display panel 1.

Image processor 300 receives external image signals which are analog signals such as PC signals, DVD signals, video signals, TV signals, etc., converts the analog signals into digital signals, image-processes the digital signals, and outputs the image-processed internal image signals. The internal image signals are respectively 8-bit red, green, and blue image data, clock signals, and vertical and horizontal synchronization signals.

Logic controller 302 receives internal image signals from image processor 300 and generates an address driving control signal S_{A}, a Y driving control signal S_{Y}, and an X driving control signal S_{X} through gamma correction, error extension, and automatic power control (APC) processes.

Y driver 304, address driver 306, and X driver 308 respectively receives driving control signals S_{Y}, S_{A}, and S_{X}, and outputs the corresponding driving signals to scan electrodes Y₁, . . . , Yₙ, address electrodes A₁, . . . , Aₘ, and sustain electrodes X₁, . . . , Xₙ of plasma display panel 1.

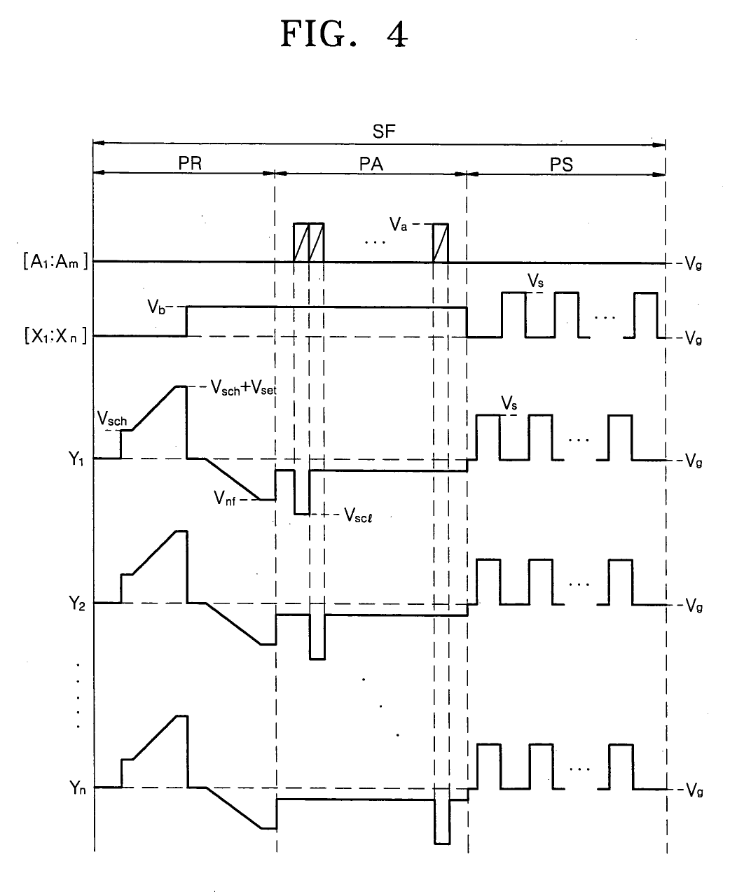

FIG. 4 is a timing diagram of the driving signals output by each driver illustrated in FIG. 3.

Referring to FIG. 4, a unit frame used to drive plasma display panel 1 illustrated in FIG. 1 is divided into a plurality of subfields, and each subfield SF includes a reset period PR, an address period PA, and a sustain-discharge period PS. During reset period PR, wall charges status of all discharge cells illustrated in FIG. 2 are initialized to make wall charges suitable for address period PA. During address period PA, a discharge cell that is to be turned on is selected (addressed) from all discharge cells. During sustain period PS, the discharge cell selected during address period PA performs sustain discharges according to gray scale weights allocated on each subfield SF. The unit frame can have a variety of numbers of subfields according to design specifications. Each subfield SF can selectively have a reset period PR according to design specifications. Also, gray scale weight of each subfield SF and the number of sustain pulses (the lengths of sustain pulses) applied during sustain-discharge period PS can be modified according to an APC process, gamma characteristics, and panel characteristics.

During reset period PR, a reset pulse including a rising pulse and a falling pulse, is applied to scan electrodes Y₁ through Yₙ, and a bias voltage V_{b} is applied to sustain electrodes X₁ through Xₙ when the falling pulse is applied to perform a reset discharge, and the falling pulse in the reset period has a start portion and an end portion set to apply a fixed voltage. The reset discharge initializes all discharge cells. The rising part rises from a scan high voltage Vsch by adding a rising voltage Vset to finally a rising maximum voltage Vset+Vsch. The falling pulse falls from a local reference voltage such as a ground voltage Vg to finally a falling minimum voltage Vnf. As shown in FIG. 4, the rising pulse and the falling pulse can be realized in the form of a ramp pulse.

During address period PA, a scan pulse is sequentially applied to Y electrodes Y₁ through Yₙ, and an address pulse is applied to address electrodes A₁ through Aₘ in accordance with the scan pulse to perform an address discharge, so that the discharge cells for performing a sustain discharge during the sustain-discharge period PS can be selected. The scan pulse sequentially has a high level Vsch+Vscl and a low level Vscl (scan low voltage). The address pulse has a positive address voltage Va in accordance with the application of scan low voltage Vscl of the scan pulse. To increase the stability of the address discharge, scan low voltage Vscl is lower than falling minimum voltage Vnf.

During sustain-discharge period PS, a sustain pulse is alternately applied to sustain electrodes X₁ through Xₙ and scan electrodes Y₁ through Yₙ to perform a sustain discharge. The brightness of a unit field including a plurality of subfields is expressed by performing the sustain discharge according to gray scale weights allocated to each subfield. The sustain pulse has alternately a high level and a low level; the voltage difference between the high level and the low level is enough to induce a sustain discharge using wall charges accumulated around the scan electrodes and the sustain electrode in the address period. The high level of the sustain pulse is a sustain voltage Vs, and the low level of the sustain pulse is a ground voltage Vg. But the present invention is not limited thereto. For example, the low level of the sustain pulse can use a negative sustain voltage −Vs.

Meanwhile, each driver illustrated in FIG. 3 outputs the driving signal illustrated in FIG. 4 but the present invention is not limited thereto.

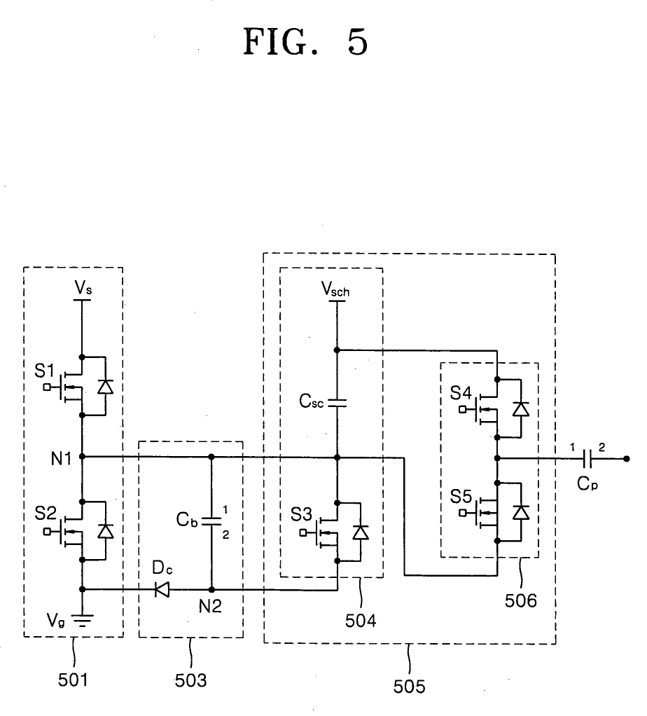

FIG. 5 is a circuit diagram illustrating a plasma display panel driving apparatus according to an embodiment of the principles of the present invention.

Referring to FIG. 5, the plasma display panel driving apparatus of the current embodiment of the present invention includes a scan pulse application portion 505 that generates a scan pulse and outputs the scan pulse to scan electrodes Y₁ through Yₙ among a plurality of electrodes, a sustain pulse generation portion 501 that generates a sustain pulse, and a bootstrap portion 503 that performs bootstrap operation using a high level and a low level of the sustain pulse and generates a low level voltage of the scan pulse. The plasma display panel driving apparatus is expressed as a panel capacitor Cp. It is assumed that a first terminal of panel capacitor Cp is a scan electrode of the plasma display panel, and a second terminal of panel capacitor Cp is a sustain electrode of the plasma display panel.

Scan pulse application portion 505 generates scan pulse which is sequentially applied to scan electrodes Y₁ through Yₙ during address period PA. The scan pulse maintains the high level and abruptly has the low level. To this end, scan pulse application portion 505 includes a scan pulse generation portion 504 and a scan switching portion 506.

Scan pulse generation portion 504 generates a high level of the scan pulse using low level Vscl of the scan pulse generated by bootstrap portion 503 and a first voltage source Vsch. To this end, scan pulse generation portion 504 includes a scan voltage switching element S3 connected between a first node N1 and a second node N2 to perform a switching operation, and a scan capacitor Csc that stores first voltage level Vsch and low level Vscl of the scan pulse and that is connected between first voltage source Vsch and first node N1.

Scan switching portion 506 outputs the scan pulse generated by scan pulse generation portion 504 to the scan electrodes of the plasma display panel, i.e., the first terminal of panel capacitor Cp. To this end, scan switching portion 506 includes a first scan switching element S4 that receives high level Vsch+Vscl of the scan pulse and transfers it to the first terminal of panel capacitor Cp by a switching operation, and a second scan switching element S5 that receives low level Vscl of the scan pulse and transfers it to the first terminal of panel capacitor Cp by the switching operation. A switching element may be connected between first voltage source Vsch and scan capacitor Csc, but the present invention should not be construed as being limited to this embodiment

In detail, if second voltage switching element S1 and third voltage switching element S2 are turned off, and if scan voltage switching element S3 of scan pulse generation portion 504 is turned on, low level Vscl of the scan pulse generated by bootstrap portion 503 is stored in scan capacitor Csc. Meanwhile, when first scan switching element S4 is turned on and second scan switching element S5 is turned off, high level Vsch+Vscl of the scan pulse generated by the first voltage source Vsch and scan capacitor Csc is transferred to the first terminal of panel capacitor Cp through scan switching element S4. On the other hand, when first scan switching element S4 is turned off and second scan switching element S5 is turned on, low level Vscl of the scan pulse is transferred to the first terminal of panel capacitor Cp.

Sustain pulse generation portion 501 generates the sustain pulse applied to scan electrodes Y₁ through Yₙ during sustain period PS. The sustain pulse has alternately the high level (supplied by a second voltage source Vs) and the low level (supplied by a third voltage source Vg). The high level and the low level can be set as a variety of forms. The high level is, however, sustain voltage Vs and the low level is ground voltage Vg as illustrated in FIG. 4. Sustain pulse generation portion 501 includes second voltage source Vs, a second voltage switching element S1, third voltage source Vg, and a third voltage switching element S2.

Second voltage source Vs supplies high level Vs of the sustain pulse. Second voltage switching element S1 is connected between second voltage source Vs and first node N1, and transfers second voltage Vs to first node N1. Third voltage source Vg supplies low level Vg of the sustain pulse. Third voltage switching element S2 is connected between third voltage source Vg and first node N1 and transfers third voltage Vg to first node N1.

Bootstrap portion 503 performs a bootstrap operation using high level Vs and low level Vg of the sustain pulse, and generates low level voltage Vscl of the scan pulse. To this end, bootstrap portion 503 includes a bootstrap capacitor Cb and a clamping diode D2.

In detail, bootstrap capacitor Cb is connected between first node N1 and second node N2. Clamping diode Dc is connected between second node N2 and third voltage source Vg, i.e., second node N2 and ground terminal Vg. If second voltage switching element S1 of sustain pulse generation portion 501 is turned on, a voltage corresponding to second voltage Vs is applied across bootstrap capacitor Cb and clamping diode Dc connected in serial. A voltage obtained by subtracting a clamping voltage Vc applied to clamping diode Dc from second voltage Vs is stored in bootstrap capacitor Cb. In other words, the voltage stored in bootstrap capacitor Cb is Vs−Vc. Next, if third voltage switching element S2 of sustain pulse generation portion 501 is turned on and second voltage switching element S1 is turned off, a voltage of first node N1 is changed to the third voltage, i.e., ground voltage Vg. At this time, an electric potential of the first terminal of bootstrap capacitor Cb connected to first node N1 changes from Vs to Vg. Therefore, an electric potential of the second terminal of bootstrap capacitor Cb, i.e., an electric potential of second node N2, changes. The electric potential of second node N2 is a voltage Vg−(Vs−Vc)=−Vs+Vc, which generates the low level (Vscl=−Vs+Vc) of the scan pulse having an electric potential higher than negative electric potential −Vs of the sustain voltage. The present invention uses a simply generated low level Vscl of the sustain pulse, thereby reducing manufacturing costs. In a contemporary driving apparatus for a plasma display panel, a difference between voltages applied to both ends of scan voltage switching element S3 of scan pulse generation portion 505 is about 380 volts that is a difference between second voltage Vs (about 200 volts) and low level Vscl (about −180 volts) of the scan pulse. Therefore, a switching element having a high pressure (i.e. large voltage difference applied between both ends of the switching element) has been contemporarily used. In the plasma display panel driving apparatus of the current embodiment of the present invention, however, ground voltage Vg is applied to first node N1, and low level Vscl of the scan pulse is applied to second node N2. Therefore, a difference between voltages applied to both ends of scan voltage switching element S3 is sharply reduced to about 180 volts. Therefore, scan voltage switching device S3 can have a low pressure (i.e. small voltage difference applied between both ends of the switching element), which entails the reduction of manufacturing costs.

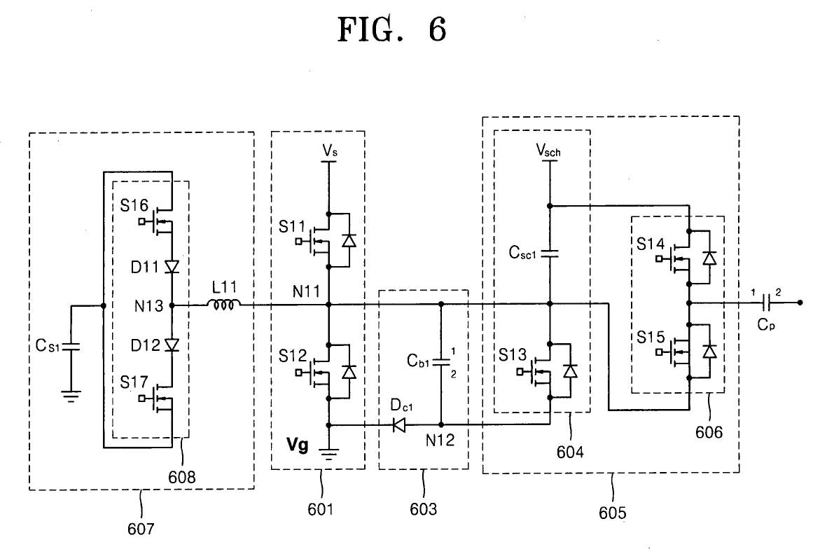

FIG. 6 is a circuit diagram illustrating a plasma display panel driving apparatus according to another embodiment of the present invention.

Referring to FIG. 6, the plasma display panel driving apparatus includes a scan pulse application portion 605, a sustain pulse generation portion 601, a bootstrap portion 603, and an energy recovery portion 607.

Scan pulse application portion 605 includes a scan pulse generation portion 604 and a scan switching portion 606. Scan pulse generation portion 604 includes a first voltage source Vsch, a scan switching element S13, and a scan capacitor Csc1. Scan switching portion 606 includes a first scan switching element S14, and a second scan switching element S15. Sustain pulse generation portion 601 includes a second voltage source Vs, a third voltage source Vg, a second voltage switching element S11, and a third voltage switching element S12. Bootstrap portion 603 includes a bootstrap capacitor Cb1 and a clamping diode Dc1. Scan pulse application portion 605, scan pulse generation portion 601, and bootstrap portion 603 are described in FIG. 5 and thus their description is omitted.

Energy recovery portion 607 recovers wall charges of the plasma display panel to store them, and transmits the stored wall charges to the plasma display panel to reduce energy consumption. In particular, during the application of the sustain pulse, when the voltage at first node N11 rises from third voltage Vg to second voltage Vs, and when the voltage at first node N11 falls from second voltage Vs to third voltage Vg, an LC resonance is established.

To this end, energy recovery portion 607 includes an inductor L11, an energy recovery determination portion 608, and an energy storage portion Cs1.

Inductor L11 produces a capacitance component of panel capacitor Cp and establishes the LC resonance. The LC resonance is established when the voltage at first node N11 rises from third voltage Vg to second voltage Vs, and when the voltage at first node N11 falls from second voltage Vs to third voltage Vg. Inductor L11 is disposed between first node N11 and third node N13.

Energy recovery determination unit 608 determines whether to recover the wall charges of the plasma display panel to store them or to transfer the stored wall charges to the plasma display panel. To this end, the energy recovery determination portion 608 includes a rising switching element S16 that performs a switching operation when the voltage at first node N11 rises from third voltage Vg to second voltage Vs, and a falling switching element S17 that performs the switching operation when the voltage at first node N11 falls from second voltage Vs to third voltage Vg. Energy recovery determination portion 608 further includes diodes D11 and D12 that pass current in a direction when the voltage at first node N11 rises from third voltage Vg to second voltage Vs, and when the voltage at first node N11 falls from second voltage Vs to third voltage Vg. In detail, the pair of rising switching element S16 and first diode D11, and the pair of falling switching element S17 and second node D12 are disposed in parallel to each other between energy storage portion Cs1 and third node N13. In conclusion, the sustain pulse illustrated in FIG. 4 is divided into four periods where rising switching element S16 is turned on, second voltage switching element S11 is turned on, falling switching element S17 is turned on, and third voltage switching element S12 is turned on. When rising switching element S16 is turned on and second voltage switching element S11 is turned on, the voltage at first node N11 rises from third voltage Vg to second voltage Vs, and the wall charged stored in energy storage portion Cs1 is transferred to the plasma display panel; when falling switching element S17 is turned on and third voltage switching element S12 is turned on, the voltage at first node N11 falls from second voltage Vs to third voltage Vg, and the wall charges of the plasma display panel is recovered and stored in energy storage portion Cs1. Energy storage portion Cs1 can be realized as a capacitor element as illustrated in FIG. 6.

The plasma display panel driving apparatus of the current embodiment of the present invention generates low level Vscl of the scan pulse using bootstrap portion 603, which reduces the number of power levels generate by a power supply device (not shown), thereby reducing manufacturing costs. Also, the plasma display panel driving apparatus of the current embodiment of the present invention can use scan switching device S13 having a low pressure.

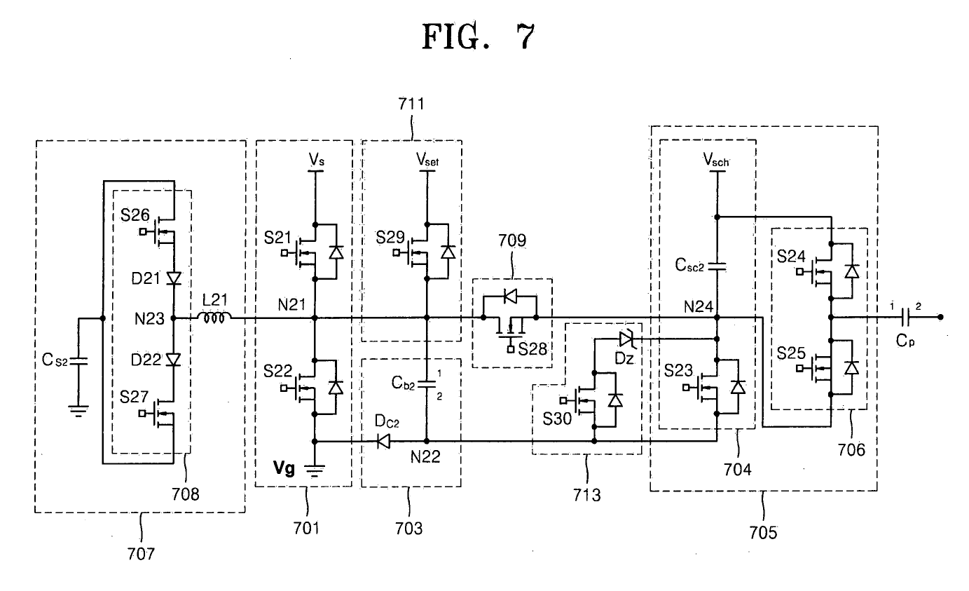

FIG. 7 is a circuit diagram illustrating a plasma display panel driving apparatus according to another embodiment of the principles of the present invention.

Referring to FIG. 7, the plasma display panel driving apparatus according to another embodiment of the principles of the present invention includes a scan pulse application portion 705, a sustain pulse generation portion 701, a bootstrap portion 703, an energy recovery portion 707, a rising ramp pulse generation portion 711, a falling ramp pulse generation portion 713, and a switching portion 709.

Scan pulse application portion 705 includes a scan pulse generation portion 704 and a scan switching portion 706. Scan pulse generation portion 704 includes a first voltage source Vsch, a scan switching element S23, and a scan capacitor Csc2. Scan switching portion 706 includes a first scan switching element S24 and a second scan switching element S25. Sustain pulse generation portion 701 includes a second voltage source Vs, a third voltage source Vg, a second voltage switching element S21, and a third voltage switching element S22. Bootstrap portion 703 includes a bootstrap capacitor Cb2 and a clamping diode Dc2. Energy recovery portion 707 includes an inductor L21, an energy recovery determination portion 708, and an energy storage portion Cs2. Energy recovery determination portion 708 includes a rising switching element S26, a first diode D21, a falling switching element S27, and a second diode D22. Scan pulse application portion 705, sustain pulse generation portion 701, bootstrap portion 703, and energy recovery portion 707 are described in FIGS. 5 and 6 and thus their description is omitted.

Rising ramp pulse generation portion 711 generates a rising ramp pulse and applies the rising ramp pulse to scan electrodes, i.e., a first terminal of a panel capacitor Cp. To this end, rising ramp pulse generation portion 711 includes a sixth voltage source Vset and a rising ramp switching element S29. Rising ramp switching element S29 is disposed between sixth voltage source Vset and a first node N21. Sixth voltage source Vset is transferred to first node N21 when rising ramp switching element S29 is turned on. A capacitor (not shown) is disposed between a gate terminal and a source terminal of rising ramp switching element S29 so that sixth voltage source Vset in the form of a ramp pulse is transferred to first node N21. Sixth voltage Vset is transferred to fourth node. N24 through switching device S28, stored in scan capacitor Csc2, combined with first voltage Vsch from first voltage source Vsch to generate rising maximum voltage Vsch+Vset, and the rising maximum voltage is transferred to the first terminal of panel capacitor Cp when first scan switching element S24 of scan switching portion 706 is turned on. In conclusion, the rising ramp pulse as illustrated in FIG. 4 is transferred to the first terminal of panel capacitor Cp.

Falling ramp pulse generation portion 713 generates a falling ramp pulse to apply the falling ramp pulse to scan electrodes, i.e., the first terminal of panel capacitor Cp. To this end, falling ramp pulse application portion 713 uses a low level Vscl of the scan pulse generated by bootstrap portion 703. In detail, a falling ramp switching element S30 is connected to second node N22, and to increase the falling ramp pulse by a certain level, a Zener diode Dz is disposed between falling ramp switching element S30 and fourth node N24. A capacitor (not shown) can be disposed between a gate terminal and a source terminal of falling ramp switching element S30 so that a falling minimum voltage Vnf in the form of a ramp pulse is transferred to fourth node N24. Falling minimum voltage Vnf is transferred to the first terminal of panel capacitor Cp when second scan switching element S25 of scan switching portion 706 is turned on. In conclusion, the falling ramp pulse illustrated in FIG. 4 is transferred to the first terminal of panel capacitor Cp.

Switching portion 709 is connected between first node N21 and fourth node N24, and transfers the sustain pulse from sustain pulse generation portion 701 and the rising ramp pulse from rising ramp pulse generation portion 711 to fourth node N24. The sustain pulse and the rising ramp pulse transferred to fourth node N24 are subsequently transferred to the first terminal of panel capacitor Cp through scan switching portion 706 of sustain pulse application portion 705. While the scan pulse generated by scan pulse application portion 705 is transferred to the first terminal of switching portion S28, switching portion S28 of switching portion 709 is turned off to protect circuitry elements of sustain pulse generation portion 701, energy recovery portion 707, bootstrap portion 703, and rising ramp pulse generation portion 711.

Like the previous embodiments illustrated in FIGS. 5 and 6, the plasma display panel driving apparatus of the current embodiment of the present invention generates low level Vscl of the scan pulse using bootstrap 703, which reduces the number of power levels generate by a power supply device (not shown), thereby reducing manufacturing costs. Also, the plasma display panel driving apparatus of the current embodiment of the present invention can use scan switching device S23 having a low pressure.

As described above, the present invention has the following effects.

The plasma display panel driving apparatus generates a low level of a scan pulse using a sustain voltage and a ground voltage, which reduces the number of power levels generated by a power supply device, thereby reducing manufacturing costs. Further, a difference between voltages applied to both ends of a scan switching element is reduced, so that a scan switching element having a low pressure can be used, thereby reducing manufacturing costs.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for driving a plasma display panel constructed with a plurality of electrodes, the apparatus comprising:
a scan pulse application portion generating a scan pulse and outputting the scan pulse to first electrodes among the plurality of electrodes;
a sustain pulse generation portion generating a sustain pulse; and
a bootstrap portion performing a bootstrap operation and generating a low level voltage of the scan pulse using a high level and a low level of the sustain pulse.

2. The apparatus of claim 1, with the bootstrap portion comprises:
a bootstrap capacitor performing the bootstrap operation; and
a clamping diode performing a clamping operation.

3. The apparatus of claim 2, with the bootstrap portion storing a difference between electric potentials of the high level and the low level of the sustain pulse in the bootstrap capacitor and the clamping diode, and inputting the high level of the sustain pulse to a first terminal of the bootstrap capacitor.

4. The apparatus of claim 3, if a difference between electric potentials of the high level of the low level of the sustain pulse is Vs, and a clamping voltage of the clamping diode is Vc, after inputting the high level, with a voltage of a second terminal of the bootstrap capacitor, being −Vs+Vc and being used as a low level of the scan pulse.

5. The apparatus of claim 1, with the scan pulse application portion comprising:
a scan pulse generation portion generating a high level of the scan pulse using a low level of the scan pulse and a first voltage source; and
a scan switching portion sequentially outputting the high level and the low level of the scan pulse to the first electrodes.

6. The apparatus of claim 5, with the scan switching portion comprising:
a first scan switching element outputting the high level of the scan pulse to the first electrodes; and
a second scan switching element outputting the low level of the scan pulse to the first electrodes.

7. The apparatus of claim 6, with the scan pulse generation portion comprising:
the first voltage source;
a scan voltage switching element switching the low level of the scan pulse; and
a scan capacitor storing the low level of the scan pulse, when the scan voltage switching element is turned on, with the low level of the scan pulse being transferred to the second scan switching element, or the high level of the scan pulse generated by the low level of the scan pulse and the first voltage from the first voltage source being transferred to the first scan switching element.

8. The apparatus of claim 1, with the sustain pulse generator comprising:
a second voltage source supplying the high level of the sustain pulse;
a third voltage source supplying the low level of the sustain pulse;
a second voltage switching element connected between the second voltage source and a first node and transferring the second voltage to the first node; and
a third voltage switching element connected between the first node and the third voltage source and transferring the third voltage to the first node.

9. The apparatus of claim 8, with the bootstrap portion comprising:
a bootstrap capacitor disposed between the first node and a second node; and
a clamping diode disposed between the second node and a ground node.

10. The apparatus of claim 9, with, when the second voltage switching element is turned on, a fourth voltage obtained by subtracting a clamping voltage applied to the clamping diode from the second voltage, being stored in the bootstrap capacitor; and
when the third voltage switching element is turned on, a voltage of the first node being the third voltage, a voltage of the second node being a fifth voltage obtained by subtracting the fourth voltage from the third voltage, and the fifth voltage being used as the low level of the scan pulse.

11. The apparatus of claim 10, with the third voltage being a ground voltage.

12. The apparatus of claim 1, further comprising an energy recovery portion recovering wall charges from the plasma display panel to store them or purging the stored wall charges to the plasma display panel in order to reduce power consumption when the sustain pulse is generated.

13. The apparatus of claim 12, with the energy recovery portion comprising:
an inductor acting as a capacitance component of the plasma display panel to establish an LC resonance when the wall charges from the plasma display panel are recovered or the stored wall charges are purged;
an energy recovery determination portion determining whether to recover the wall charges from the plasma display panel or to purge the stored wall charges to the plasma display panel; and
an energy storage portion storing the recovered wall charges.

14. The apparatus of claim 13, with the energy recovery determination portion comprising:
a falling switching element determining to recover the wall charges from the plasma display panel; and
a rising switching element determining to purge the stored wall charges to the plasma display panel.

15. The apparatus of claim 1, further comprising:
a rising ramp pulse generation portion generating a rising ramp pulse to be applied to the first electrodes; and
a falling ramp pulse generation portion generating a falling ramp pulse to be applied to the first electrodes.

16. The apparatus of claim 15, with the falling ramp pulse application portion comprising:
a falling ramp switching element coupled to perform ramp switching in response to reception of bootstrap portion; and
a Zener diode connected to the falling ramp switching element.

17. The apparatus of claim 15, with the rising ramp pulse application portion comprising:
a sixth voltage source; and
a rising ramp switching element receiving a sixth voltage from the sixth voltage source to perform the ramp switching.
